(19) United States
(12) Patent Application Publication
(10) Pub. No.: US 2015/0336037 A1
(43) Pub. Date: Nov. 26, 2015

(54) Fuel System with Ice and Large Debris Separator Filter

(71) Applicant: UNITED TECHNOLOGIES CORPORATION, Hartford, CT (US)

(72) Inventor: Taylor Fausett, San Diego, CA (US)

(73) Assignee: United Technologies Corporation, Hartford, CT (US)

(21) Appl. No.: 14/759,549

(22) PCT Filed: Jan. 8, 2013
(86) PCT No.: PCT/US13/20660

§ 371 Date: Jul. 7, 2015

(51) Int. Cl. B01D 35/30

(52) U.S. Cl. CPC B01D 35/30

(57) ABSTRACT

A filter includes an outlet from a container, the outlet transverse to said inlet. A filter screen within the container that segregates the outlet.

### BACKGROUND

The present disclosure relates to a fuel system, and more particularly to a filter therefor.

Aircraft fuel systems, because of the wide range of environmental conditions in which aircraft operate, may be susceptible to ice clogging. The ice, in rare instances, may lodge in servo valves and other calibrated fuel system components.

Conventional aircraft fuel system filters may be limited in ice management. Either the filter is fine enough to filter debris to a desired fine level and may be susceptible to a pressure drop due to ice or the filter is designed with respect to ice and is inherently too coarse to filter debris to a desired level. Ice separators that rely solely on geometry to accomplish the separation of ice and debris with no filter screen may also be ineffective because of the wide range of fuel flow speeds typical of aircraft fuel systems.

Icing may not only be an issue for aircraft main engines, but may be an even more acute issue for aircraft Auxiliary Power Units (APUs) as APUs typically rest in flight at a no flow condition, may gather ice, then may suddenly, be tasked with operation in a freezing condition.

### SUMMARY

A filter according to one disclosed non-limiting embodiment of the present disclosure includes a container, an inlet to the container, an outlet from the container, the outlet transverse to the inlet, and a filter screen within the container that segregates the outlet.

In a further embodiment of the foregoing embodiment, the filter screen prevents passage of particles greater in size than 1500 microns.

In a further embodiment of any of the foregoing embodiments, the filter screen provides a pressure drop of less than 0.5 psi.

In a further embodiment of any of the foregoing embodiments, the filter screen provides a surface area at least ten times that of the inlet.

In a further embodiment of any of the foregoing embodiments, the filter screen extends for a length of the container.

In a further embodiment of any of the foregoing embodiments, the filter screen is in-line with a fuel conduit. In the alternative or additionally thereto, in the foregoing embodiment the inlet is offset to provide a cyclonic flow.

In a further embodiment of any of the foregoing embodiments, the inlet is offset to provide a cyclonic flow.

In a further embodiment of any of the foregoing embodiments, the inlet is approximately 0.25″ (6 mm) in diameter.

A filter according to another disclosed non-limiting embodiment of the present disclosure includes a container, an inlet to the container, an outlet from the container, the outlet transverse to the inlet, and a filter screen within the container that surrounds the outlet, the filter screen provides a surface area at least ten times that of the inlet.

In a further embodiment of the foregoing embodiment, the filter screen extends for a length of the container.

In a further embodiment of any of the foregoing embodiments, the filter screen prevents passage of particles greater in size than 1500 microns.

In a further embodiment of any of the foregoing embodiments, the filter screen provides a pressure drop of less than 0.5 psi.

In a further embodiment of any of the foregoing embodiments, the filter screen extends for a length of the container.

In a further embodiment of any of the foregoing embodiments, the inlet is offset to provide a cyclonic flow.

A filter according to another disclosed non-limiting embodiment of the present disclosure includes a container, an inlet to the container, an outlet from the container, the outlet transverse to the inlet, and a filter screen located in an end section of the outlet.

In a further embodiment of the foregoing embodiment, the inlet is offset to provide a cyclonic flow.

In a further embodiment of any of the foregoing embodiments, the inlet is approximately 0.25″ (6 mm) in diameter. In the alternative or additionally thereto, in the foregoing embodiment the outlet is larger than the inlet.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of a fuel system for a gas turbine engine; and

FIG. 2 is an enlarged sectional view of a filter according to one disclosed non-limiting embodiment;

FIG. 3 is an enlarged sectional view of a filter according to one disclosed non-limiting embodiment;

FIG. 4 is an enlarged sectional view of a filter according to one disclosed non-limiting embodiment;

FIG. 5 is an enlarged sectional view of a filter according to one disclosed non-limiting embodiment;

FIG. 6 is an enlarged lateral sectional view of the filter of FIG. 5 illustrating a cyclonic flow.

### DETAILED DESCRIPTION

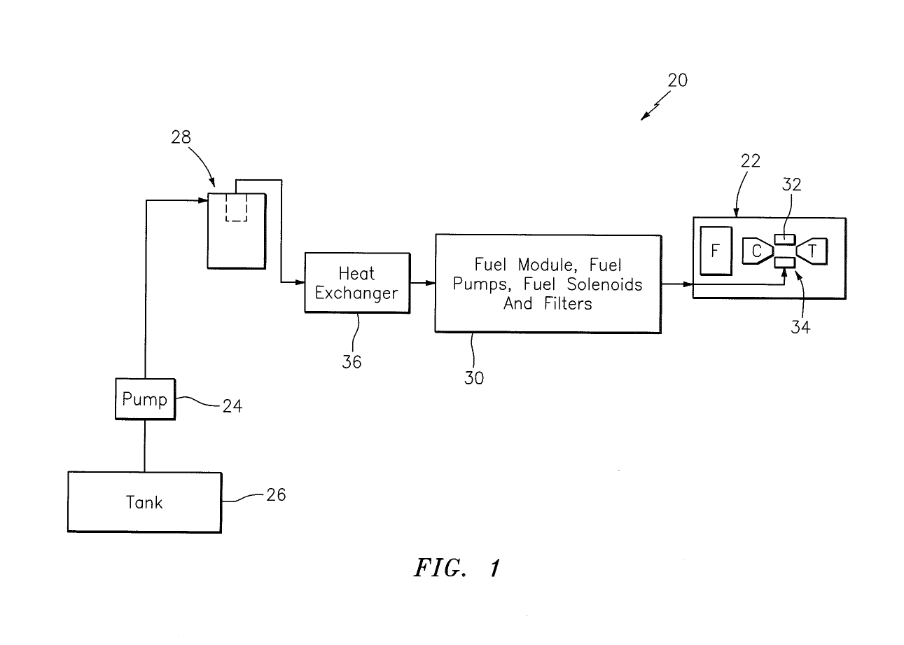

FIG. 1 schematically illustrates a fuel system 20 for an engine 22. The engine 22 may be, for example but not limited to, a gas turbine engine utilized for propulsion of an aircraft, a gas turbine engine utilized as an auxiliary power unit (APU), or other system.

The fuel system 20 generally includes a main pump 24 to supply fuel from a relatively low pressure fuel source 26 through a filter 28 to a fuel subsystem 30 thence to a fuel manifold 32 in a combustor section 34 of the engine 22. The fuel subsystem 30 may include various components such as fuel modules, high-pressure pumps, solenoid valves, metering valves, shut-off valves, spill valves, and other filters. It should be appreciated that various other, systems, subsystems and components may alternatively or additionally be provided and are contemplated as included by the fuel subsystem 30.

The filter 28 may also be immediately upstream of a heat exchanger 36 that is optionally employed within the fuel system 20. It should be appreciated that the heat exchanger 36 may be directly associated with the engine 22 and/or distributed elsewhere in the larger system 20. The heat exchanger 36 may alternatively or additionally include a multiple of heat exchangers distributed throughout the fuel system 20.

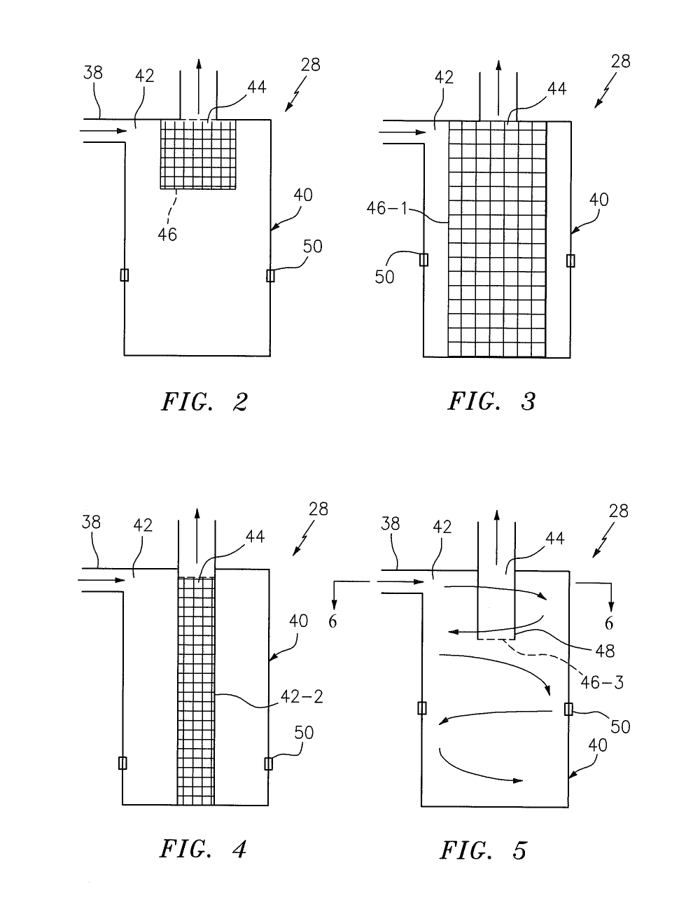

With reference to FIG. 2, the filter 28 in the disclosed non-limiting embodiment provides ice and debris separation and may alternatively be referred to as an ice and debris separator (IDS). A fuel conduit 38, typically approximately 0.25″ (6 mm) in diameter, communicates with a container 40 at an inlet 42. The container 40 includes an outlet 44 transverse to the inlet 42 such as in a top section of the container 40. It should be appreciated that the outlet may alternatively be located in a bottom or other section of the container 40.

In one disclosed non-limiting embodiment, the container 40 includes a relatively large surface area filter screen 46 that segregates the outlet 44. “Segregates” as defined herein allows the filter screen 46 to filter material prior to fuel egress through the outlet. That is, no alternative path is provided but through the filter screen 46.

The filter screen 46 may be, in this non-disclosed embodiment, a screen, a perforated tube or other such filter element. In one disclosed non-limiting embodiment, the filter screen 46 provides a pressure drop of less than 0.5 psi and prevents passage of particles greater in size than, for example, between 40 to 6000 microns in and in particular, 1500 microns. In this disclosed non-limiting embodiment, the filter screen 46 provides a surface area approximately 10 times that of the inlet 42.

The container 40 collects ice and debris. Over time, the ice will eventually melt in the container and be communicated out of the container 40 through the filter screen 46. Debris may eventually removed in normal maintenance operations. To facilitate maintenance operations, the container 40 may include an interface 50 such as thread to disassemble the container 40.

With reference to FIG. 3, another disclosed non-limiting embodiment extends the filter screen 46-1 along the entire length of the container 40. That is, the filter screen 46-1 is significantly larger than the outlet 44 and extends for the length of the container 40.

With reference to FIG. 4, another disclosed non-limiting embodiment extends the filter screen 46-2 along the entire length of the container 40 and is approximately the diameter of the outlet 44.

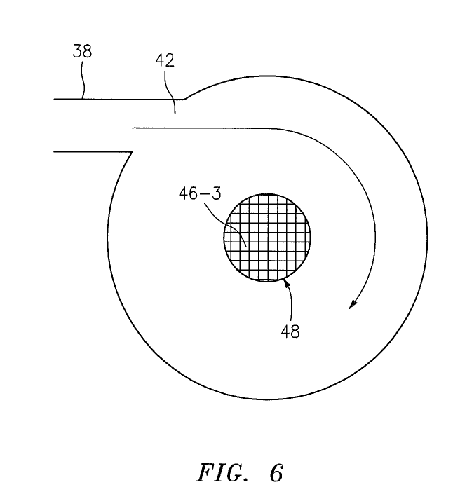

With reference to FIG. 5, another disclosed non-limiting embodiment locates the filter screen 46-3 in an end section 48 of the outlet 44. The inlet 42 may be offset to provide a cyclonic flow (FIG. 6).

The IDS provides ice and large debris defense upstream of the fuel subsystem 30 to ensure released ice or large debris does not effect calibrated fuel system equipment. The IDS also has a relative small pressure drop in a low pressure area of the system 20 to provide ice and debris defense yet not cause the pump cavitation.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A filter comprising:
a container;
an inlet to said container;
an outlet from said container, said outlet transverse to said inlet; and
a filter screen within said container that segregates said outlet.

2. The filter as recited in claim 1, wherein said filter screen prevents passage of particles greater in size than 1500 microns.

3. The filter as recited in claim 1, wherein said filter screen provides a pressure drop of less than 0.5 psi.

4. The filter as recited in claim 1, wherein said filter screen provides a surface area at least ten times that of the inlet.

5. The filter as recited in claim 1, wherein said filter screen extends for a length of said container.

6. The filter as recited in claim 1, wherein said filter screen is in-line with a fuel conduit.

7. The filter as recited in claim 6, wherein said inlet is offset to provide a cyclonic flow.

8. The filter as recited in claim 1, wherein said inlet is offset to provide a cyclonic flow.

9. The filter as recited in claim 1, wherein said inlet is approximately 0.25″ (6 mm) in diameter.

10. A filter comprising:
a container;
an inlet to said container;
an outlet from said container, said outlet transverse to said inlet; and
a filter screen within said container that surrounds said outlet, said filter screen provides a surface area at least ten times that of the inlet.

11. The filter as recited in claim 10, wherein said filter screen extends for a length of said container.

12. The filter as recited in claim 10, wherein said filter screen prevents passage of particles greater in size than 1500 microns.

13. The filter as recited in claim 10, wherein said filter screen provides a pressure drop of less than 0.5 psi.

14. The filter as recited in claim 10, wherein said filter screen extends for a length of said container.

15. The filter as recited in claim 10, wherein said inlet is offset to provide a cyclonic flow.

16. A filter comprising:
a container;
an inlet to said container;
an outlet from said container, said outlet transverse to said inlet; and
a filter screen located in an end section of the outlet.

17. The filter as recited in claim 16, wherein said inlet is offset to provide a cyclonic flow.

18. The filter as recited in claim 16, wherein said inlet is approximately 0.25″ (6 mm) in diameter.

19. The filter as recited in claim 18, wherein said outlet is larger than said inlet.
